(19) United States
(12) Patent Application Publication
(10) Pub. No.: US 2025/0031735 A1
(43) Pub. Date: Jan. 30, 2025

(54) WINE TASTING CARRIER AND CARRIER SET FOR WINE TASTING

(71) Applicant: KINPO ELECTRONICS, INC., NEW TAIPEI CITY (TW)

(72) Inventor: Chieh-Li HSU, NEW TAIPEI CITY (TW)

(21) Appl. No.: 18/911,220

(22) Filed: Oct. 9, 2024

Related U.S. Application Data
(63) Continuation-in-part of application No. 17/703,797, filed on Mar. 24, 2022.

(30) Foreign Application Priority Data
Feb. 9, 2022 (TW) 111104745

(51) Int. Cl. A23L 27/00

(52) U.S. Cl. CPC A23L 27/70

(57) ABSTRACT

A wine tasting carrier corresponding to a selected wine is disclosed. The wine tasting carrier includes: an original carrier being in a shape of human's tongue; a flavourless region arranged on the original carrier; a flavor carrying region arranged on the original carrier and providing a flavor; a producing material attached on the flavor carrying region to provide the flavor of the flavor carrying region; and a boundary line arranged on the original carrier to separate the flavor carrying region and the flavourless region. The flavor carrying region is arranged at a tip position, a middle position, a rear position, a circular area from a front to two sides, or two separated sides of the wine tasting carrier, and the flavor of the flavor carrying region is corresponding to one flavor or aroma of the selected wine according to the arranged position of the flavor carrying region.

### CROSS-REFERENCE TO RELATED APPLICATIONS

This application is a continuing-in-part application of U.S. patent application Ser. No. 17/703,797, filed on Mar. 24, 2022, which claims priority to Taiwan patent application no. 111104745 filed on Feb. 9, 2022. The entire disclosures of the above applications are all incorporated herein by reference.

### BACKGROUND OF THE INVENTION

### Technical Field

The technical field relates to wine tasting, and specifically relates to a wine tasting carrier and a carrier set for wine tasting.

### Description of Related Art

In a wine tasting occasion, the host may first introduce the taste of a specific wine or liquor such as whisky. Taking a specific wine for an example, the wine taster may drink the specific wine after the introduction is finished.

Generally, the host can only describe each specific flavor brought by the wine through vague or general nouns and adjectives. Taking whisky for an example, the host may introduce the flavors of a specific whisky through vocabularies including fruity, floral, herbaceous, nutty, earthy, caramel, smoky, peaty, etc.

However, a specific wine (or liquor) usually involves multiple different flavors at the same time, and the flavors of wines made of different wineries, methods, or years are way different. To tasters who are not familiar with the flavors of wines, it is hard for them to understand which of the tasted flavor is the one introduced by the host.

### SUMMARY OF THE INVENTION

The disclosure is directed to a wine tasting carrier and a carrier set for wine tasting, which may provide a specific flavor or aroma to produce a wine tasting carrier correspondingly, so that a wine taster may directly and specifically experience the flavor or the aroma that is brought by a selected wine through tasting the wine tasting carrier.

In one of the embodiments, the wine tasting carrier includes:
an original carrier, providing no special flavor and being in a shape of human's tongue;
a flavourless region, arranged on the original carrier;
a flavor carrying region, arranged on the original carrier and providing a flavor different from the flavor of the original carrier;
a producing material, attached on the flavor carrying region to provide the flavor of the flavor carrying region; and
a boundary line, arranged on the original carrier to divide a surface of the original carrier into the flavor carrying region and the flavourless region;
wherein, the flavor carrying region is arranged at a tip position, a middle position, a rear position, a circular area from a front to two sides, or two separated sides of the wine tasting carrier without overlapping the flavourless region, and the flavor of the flavor carrying region is corresponding to one of a plurality of flavors or aromas of a selected wine according to an arranged position of the flavor carrying region on the wine tasting carrier.

In one of the embodiments, the carrier set for wine tasting is corresponding to multiple flavors or aromas that are present in a selected wine, and the carrier set for wine tasting includes a plurality of wine tasting carriers, wherein each of the plurality of wine tasting carriers respectively includes:
an original carrier, providing no special flavor and being in a shape of human's tongue;
a flavourless region, arranged on the original carrier;
a flavor carrying region, arranged on the original carrier, providing a flavor corresponding to the selected wine and different from the flavor of the original carrier;
a producing material, attached on the flavor carrying region to provide the flavor of the flavor carrying region; and
a boundary line, arranged on the original carrier to divide a surface of the original carrier into the flavor carrying region and the flavourless region;
wherein, each of the plurality of wine tasting carriers respectively has the flavor carrying region at different position of the wine tasting carrier, and the flavor of the flavor carrying region of each of the plurality of wine tasting carriers is respectively corresponding to different flavors or aromas of the selected wine according to an arranged position of the flavor carrying region on each of the wine tasting carriers.

In comparison with the related art, the present disclosure assists the wine taster to taste a single interested flavor or aroma once at a time through the wine tasting carrier; thereby, making the wine taster to understand each flavor or aroma that is corresponding to different wines. Therefore, the wine tasting occasion may be held easily, the difficulty of wine tasting may be reduced, and the pleasure of wine tasting may be increased at the same time.

### DESCRIPTION OF THE DRAWINGS

FIG. 1 is a schematic diagram showing a wine tasting carrier of a first embodiment according to the present disclosure.

FIG. 2 is a schematic diagram showing a production line of the wine tasting carrier of an embodiment according to the present disclosure.

FIG. 3 is a flowchart of a producing method of an embodiment according to the present disclosure.

FIG. 4 is a block diagram of a producing apparatus of an embodiment according to the present disclosure.

FIG. 5 is a schematic diagram showing a producing apparatus of a first embodiment according to the present disclosure.

FIG. 6 is a schematic diagram showing the producing apparatus of a second embodiment according to the present disclosure.

FIG. 7 is a schematic diagram showing the wine tasting carrier of a second embodiment according to the present disclosure.

FIG. 8 is a schematic diagram showing the wine tasting carrier of a third embodiment according to the present disclosure.

FIG. 9a is a schematic diagram showing a feeling area of the tongue of one embodiment.

FIG. 9b is a schematic diagram showing a feeling area of the tongue of another embodiment.

FIG. 9c is a schematic diagram showing a feeling area of the tongue of another embodiment.

FIG. 9d is a schematic diagram showing a feeling area of the tongue of another embodiment.

FIG. 9e is a schematic diagram showing a feeling area of the tongue of another embodiment.

FIG. 10a is a schematic diagram showing a wine tasting carrier of one flavor according to the present disclosure.

FIG. 10b is a schematic diagram showing a wine tasting carrier of another flavor according to the present disclosure.

FIG. 10c is a schematic diagram showing a wine tasting carrier of another flavor according to the present disclosure.

FIG. 10d is a schematic diagram showing a wine tasting carrier of another flavor according to the present disclosure.

FIG. 10e is a schematic diagram showing a wine tasting carrier of another flavor according to the present disclosure.

FIG. 11 is a schematic diagram of wine tasting carrier of another embodiment according to the present disclosure.

### DETAILED DESCRIPTION OF THE INVENTION

In cooperation with the attached drawings, the technical contents and detailed description of the present invention are described hereinafter according to multiple embodiments, being not used to limit its executing scope. Any equivalent variation and modification made according to appended claims is all covered by the claims claimed by the present invention.

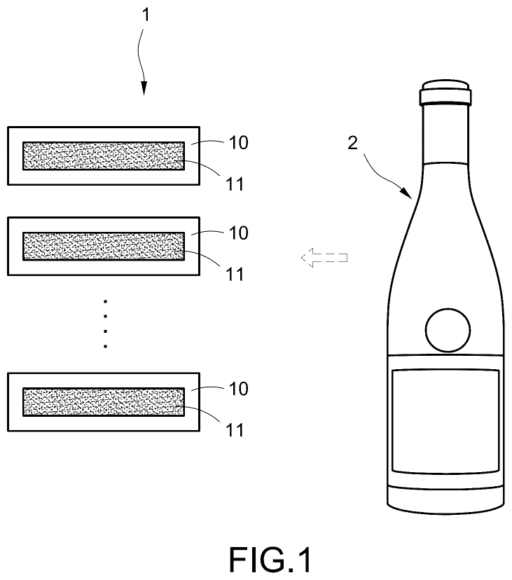

Please refer to FIG. 1, which is a schematic diagram showing a wine tasting carrier of a first embodiment according to the present disclosure. As shown in FIG. 1, a wine tasting carrier 1 is disclosed in the present disclosure, wherein one wine tasting carrier 1 is attached with one flavor 11 that is corresponding to a target wine 2. In particular, the wine tasting carrier 1 of the present disclosure is produced based on an original carrier which does not bring any special flavor, and a liquid material that may spread a flavor of the target wine 2 is attached onto the original carrier 10. The original carrier 10 may be transformed into the wine tasting carrier 1 after absorbing the liquid material attached thereon, and the liquid material attached on the wine tasting carrier 1 may provide the flavor 11 correspondingly.

The wine in the disclosure indicates different kind of alcoholic drink, such as red wine, white wine, rose wine, liquor, spirits, etc. For the ease of understanding, following description takes wine for example, but not limited thereto.

More specific, the present disclosure discloses a carrier set for wine tasting. As shown in FIG. 1, a carrier set for wine tasting includes at least two wine tasting carriers 1, each of which is respectively attached with different flavor 11 corresponding to the target wine 2.

Taking the three wine tasting carriers 1 shown in FIG. 1 as an example, a carrier set for wine tasting is constituted by the three wine tasting carriers 1, so the carrier set may provide three different flavors corresponding to the target wine 2 through the three wine tasting carriers 1. However, the quantity of the wine tasting carriers 1 is not limited to the disclosure of FIG. 1.

In the embodiment of FIG. 1, a first wine tasting carrier includes an original carrier and a first flavor attached thereon, a second wine tasting carrier includes another original carrier 10 and a second flavor attached thereon, and a third wine tasting carrier includes another original carrier 10 and a third flavor attached thereon. In this case, the first flavor, the second flavor, and the third flavor are different flavors, but the three flavors are corresponding to same wine (i.e., the target wine 2).

In one embodiment, each wine may have one carrier set correspondingly, and the quantity of the wine tasting carrier 1 included in the carrier set is corresponding to the quantity of flavors brought by the wine itself. If a wine taster is interested in a specific wine (such as a red wine, a white wine, a whisky, or a champagne, etc. made of a specific year or from a specific winery), the wine taster may obtain, produce, or purchase the carrier set related to the specific wine. Through tasting the multiple wine tasting carriers 1 of the carrier set in an indicated order, the wine taster may sequentially experience each of the multiple flavors of the specific wine.

The way the wine taster tastes the wine tasting carrier 1 is to directly put the wine tasting carrier 1 into the mouth. After the liquid material attached on the wine tasting carrier 1 is decomposed by saliva, the wine taster may obtain the flavor 11 provided by the liquid material in his mouth.

In a first embodiment, the original carrier 10 is an edible carrier, such as a rice paper membrane. When the wine taster puts the wine tasting carrier 1 into the mouth, the wine tasting carrier 1 dissolves in the mouth and directly releases the attached flavor 11 in the mouth. In a second embodiment, the original carrier 10 is made of a non-dissolvable material. As mentioned above, the flavor 11 of the wine tasting carrier 1 is provided by the liquid material. After the wine taster puts the wine tasting carrier 1 into the mouth, saliva in the mouth may decompose the liquid material attached on the wine tasting carrier 1. Therefore, the wine taster may absorb the flavor 11 of the wine tasting carrier 1 through the decomposed liquid material, while the foundation (i.e., the original carrier 10) of the wine tasting carrier 1 remains.

The carrier set of the present disclosure may be used in different wine tasting occasions, and the flavors 11 attached on the wine tasting carriers 1 may be corresponding to the flavors brought by the target wine 2 itself. Taking a specific wine for an example, if a target wine 2 may bring flavors of citrus, nutty, caramel, and sulfur after drinking, the carrier set corresponding to the target wine 2 may include four wine tasting carriers 1 respectively attached with a flavor of citrus, a flavor of nutty, a flavor of caramel, and a flavor of sulfur. Taking a specific whisky for another example, if a target wine 2 (namely, a target whisky) may bring flavors of cereal, nutty, earthy, smoky, and woody after drinking, the carrier set corresponding to the target wine 2 may include five wine tasting carriers 1 respectively attached with a flavor of cereal, a flavor of nutty, a flavor of earthy, a flavor of smoky, and a flavor of woody.

In a wine tasting occasion, a host may introduce the multiple flavors (such as a flavor of citrus and a flavor of nutty, etc.) that are brought by the target wine 2 after drinking. However, the flavors brought by a wine after drinking is complicate; therefore, the taster may not clearly understand the flavor(s) introduced by the host.

The present disclosure may pre-analyze the target wine 2, so that the flavors of the target wine 2 may be retrieved through different manners such as an extraction approach, or the flavors may be provided through liquid materials that are created by compound or composition.

In the wine tasting occasion, after the host introduces one flavor of the target wine 2, the wine taster may taste the wine tasting carrier 1 that is corresponding to the introduced flavor for the mouth and the tongue to experience the flavor, and then drinks the target wine 2 after tasting the wine tasting carrier 1. Therefore, the wine taster may be assisted to clearly understand the flavors of the target wine 2, so as to improve the pleasure of wine tasting and reduce the difficulty of the same.

In addition to the identifiable flavors brought by the wine itself, the wine may also bring different flavors at different time points or different positions in the mouth after drinking. In particular, the flavors of the wine may be further defined as a flavor of an entrance section (i.e., an entrance flavor), a flavor of a middle section (i.e., a middle flavor), a flavor of a closing section (i.e., a closing flavor), and a flavor of an aftertaste section (i.e., an aftertaste flavor), etc. In one embodiment, the multiple wine tasting carriers 1 included in the carrier set may be respectively corresponding to different flavors 11 of the target wine 2 being brought at different time points or different positions in the mouth.

In the above embodiment, after the host introduces the change in the taste of the target wine 2 with the change of time or position after drinking, the wine taster may follow the introduction order and taste the wine tasting carriers 1 accordingly. Therefore, the wine taster may first understand the change in the taste of the target wine 2 following the change of time or position in the mouth, and then drink the target wine 2 on the basis of understanding.

It should be mentioned that there are three formal steps in the professional wine tasting culture, which include an observe step, a smell step, and a taste step. In particular, an observe step means to observe the color of the wine through visual sense, a smell step means to smell the odor of the wine through olfactory sense, and a taste step means to taste the flavor of the wine through taste sense. However, the odor of the wine may not be obtained through taste sense. In other words, the target wine 2 may bring different feelings when being smelled and drank.

According to the above issue, the wine tasting carriers 1 of the present disclosure may carry different flavors of the target wine 2 for the wine taster to taste through taste sense, and may also carry different odors of the target wine 2 for the wine taster to smell through olfactory sense. In the wine tasting occasion, the wine taster may directly observe the color of the target wine 2, and the wine taster may then smell each odor and taste each flavor of the target wine 2 through using a carrier set that is corresponding to the target wine 2.

In particular, the present disclosure may extract the odor spread from the target wine 2 and produce an odor material correspondingly, and then attach the odor material to the original carrier 10 to form a wine tasting carrier 1 which may be smelled by the wine taster. In the embodiment, the carrier set corresponding to the target wine 2 may include one or more wine tasting carriers 1 that are used for the wine taster to smell and one or more wine tasting carriers 1 that are used for the wine taster to taste. In one case, the odor material may provide an odor of the target wine 2 itself. In another case, the odor material may provide an odor of one flavor brought by the target wine 2, but not limited thereto.

In one embodiment, the odor material may be liquid material, gas material, or solid material, etc. The odor material is added to the wine tasting carrier 1. A membrane (not shown) is used to cover the odor material, so as to seal the odor brought by the odor material in the wine tasting carrier 1. The membrane may be made of edible or non-edible material, and the membrane may be dissolvable or non-dissolvable, but not limited.

When the wine taster wants to use the wine tasting carrier 1, the wine taster may tear the membrane off the wine tasting carrier 1 to release the odor carried by the odor material, so that the wine taster may smell the odor. The present disclosure adds the wine tasting carrier 1 for smelling purpose into the carrier set; thereby, making the wine tasting occasion more complete and more professional.

In other embodiment, the wine tasting carrier 1 for smelling purpose may be a dry carrier carrying a demanded odor. In the embodiment, the odor of the wine tasting carrier 1 may not directly spread into the air even if the membrane is not arranged on the wine tasting carrier 1. When the wine taster wants to use the wine tasting carrier 1 for smelling, one thing needs to be done is wetting the wine tasting carrier 1 for the wine tasting carrier 1 to release the carried odor. Therefore, the wine taster may smell the odor of the target wine 2 through using the wine tasting carrier 1.

However, the above descriptions are only few embodiments of the present disclosure, but not limited thereto.

In part of the wine tasting occasions, the wine taster may wish to have a dish (such as steak, duck breast, or caviar, etc.) that is best pairing with the target wine 2. However, the wine taster may be unwilling to eat the food due to certain reasons (for example, diet reason or health reason).

In order to solve the above problem, the multiple wine tasting carriers 1 included in the carrier set of the present disclosure may be respectively attached with the flavors 11 corresponding to different food suitable for the target wine 2. When the wine taster drinks the target wine 2, he may put a corresponding wine tasting carrier 1 into the mouth, so as to taste the flavor 11 of the food that is suitable for the target wine 2. Therefore, the wine taster may have the food taste without actually eating the food. As a result, the flavor of the target wine 2 may be improved accordingly.

However, the above descriptions are only few embodiments of the present disclosure, but not limited thereto.

Generally, according to the systematic approach released by the wine and spirit education trust (WSET), a wine (or spirit) can be observed in three different aspects including appearance, nose, and palate. The appearance aspect may include clarity (such as clear and hazy), intensity (such as pale, medium, and deep), colour (such as lemon-green, lemon, gold, amber, and brown (for white wine), pink, salmon, and orange (for rose wine), purple, ruby, garnet, tawny, and brown (for red wine)), and other observations (such as legs/tears, deposit, petillance, and bubbles). The nose aspect may include condition (such as clean and unclean), intensity (such as light, medium(−), medium, medium(+), and pronounced), aroma characteristics (such as primary, secondary, and tertiary), and development (such as youthful, developing, fully developed, and tired/past its best). The palate aspect includes sweetness (such as dry, off dry, medium dry, medium sweet, sweet, and luscious), acidity (such as low, medium(−), medium, medium(+), and high), tannin (such as low, medium(−), medium, medium(+), and high), alcohol (such as low, medium, and high), body (such as light, medium(−), medium, medium(+), and full), mousse (such as delicate, creamy, and aggressive), flavour intensity (such as light, medium(−), medium, medium(+), and pronounced), flavour characteristics (such as primary, secondary, and tertiary), and finish (such as short, medium(−), medium, medium(+), and long).

When a taster smells a target wine (i.e., a wine selected by the taster from a plurality of interested wines), the wine aromas reach the taster's nose directly (i.e., orthonasal olfaction). However, when the taster takes a sip of the target wine, another wine aromas will reach the taster's nose indirectly through the retronasal passage, which is so called retronasal olfaction. Olfaction means, when sniffing or inhaling, the volatile molecules travel up the nasal passage; on the other hand, retronasal olfaction takes place when the molecules reach the olfactory bulb from the back of the mouth cavity.

Due to breathing in and out, the airflow will carry free aroma compounds through the retronasal passage to reach taster's olfactory receptors; due to so called Enzymatic Action, some wine aromas get only released once in the taster's mouth because the enzymes in the taster's saliva will break down any aroma compounds bound to aroma precursors. Also, some wine aromas are free to get airborne and reach the taster's nose, and others are bound to other molecules called precursors; Due to so called microbial activity, aroma compounds bound to the precursor molecules will be released in the taster's mouth; Due to absorption and resorption, so aroma compounds will be absorbed by the mucosa, and are let go after the taster swallows.

According to the above, that is why sometimes the aromas (and flavors) we taste are different from the aromas (and flavors) we smell from the same wine, because some aromas/flavors are bound when smelling and having no odors, but are released in our mouth after drinking the wine.

The aromas of the wine may include three categories, including primary aroma, secondary aroma, and tertiary aroma. The primary aroma may be corresponding to the grape variety of the wine, such as cherry, cassis, violet, truffle, pepper, raspberry, or leather, etc. The secondary aroma may be derived from the winemaking process and yeast used for fermentation, such as vanilla, tobacco, tea, and lemon, etc. The tertiary aroma may arise during the aging process, such as mushroom, chocolate, quince, and fig, etc.

The most common palates (flavors) of wine are sweetness, acidity, and tannin. In general, the taster may feel sweetness of the wine by the tip of the tongue, feel acidity of the wine by both sides of the tongue, and feel tannin of the wine when feeling the bitter taste by a circular part of the tongue from the front to the sides of the tongue. Also, the taster may feel the primary aroma and/or the secondary aroma of the wine by the middle of the tongue, and feel the secondary aroma and/or the tertiary aroma of the wine by the rear of the tongue. To enable the taster to respectively feel different aromas/flavors of a target wine, such as sweetness, acidity, tannin, primary aroma, secondary aroma, and tertiary aroma, the present disclosure provides the carrier set for wine tasting with multiple wine tasting carriers, each of which is respectively attached with at least one of the aromas/flavors at different position on the wine tasting carrier.

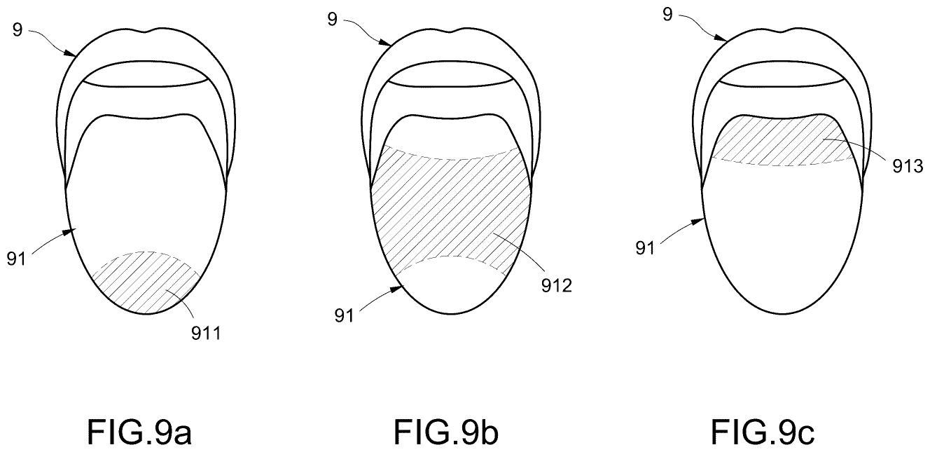

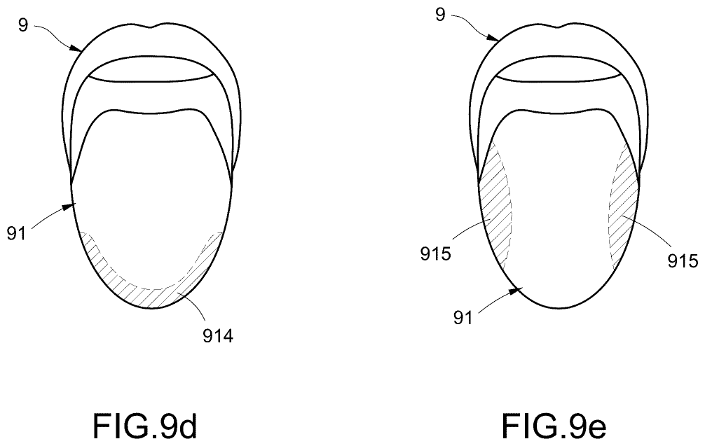

Please refer to FIG. 9a to FIG. 9e, which are the schematic diagrams showing a feeling area of the tongue respectively corresponding to different embodiments. More specifically, FIG. 9a to FIG. 9e respectively show the tongue 91 of the taster's mouth 9, wherein FIG. 9a shows a tip 911 of the tongue 91, FIG. 9b shows a middle position 912 of the tongue 91, FIG. 9c shows a rear position 913 of the tongue 91, FIG. 9d shows a circular area 914 of the tongue 91, and FIG. 9e shows two separated sides 915 of the tongue 91. As discussed above, the taster may easily feel a sweetness flavor by the tip 911 of the tongue 91, easily feel an acidity flavor by the two separated sides 915 of the tongue 91, easily feel a tannin flavor by the circular area 914 from the front to the sides of the tongue 91, easily feel the primary aroma and/or the secondary aroma by the middle position 912 of the tongue 91, and easily feel the secondary aroma and/or the tertiary aroma by the rear position 913 of the tongue 91.

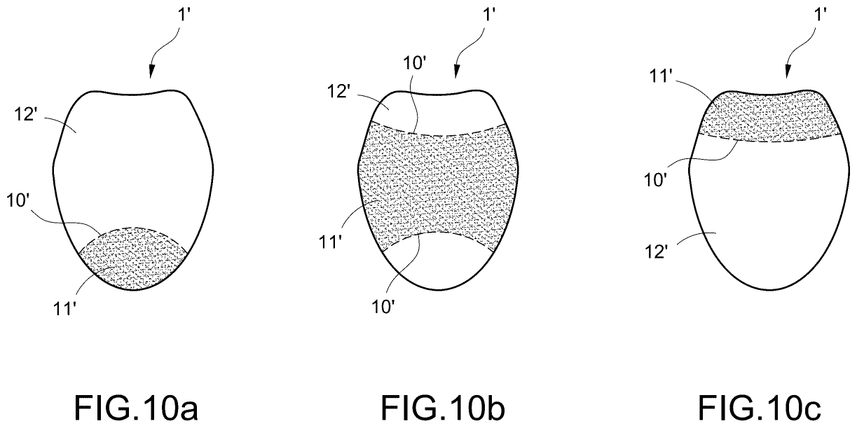

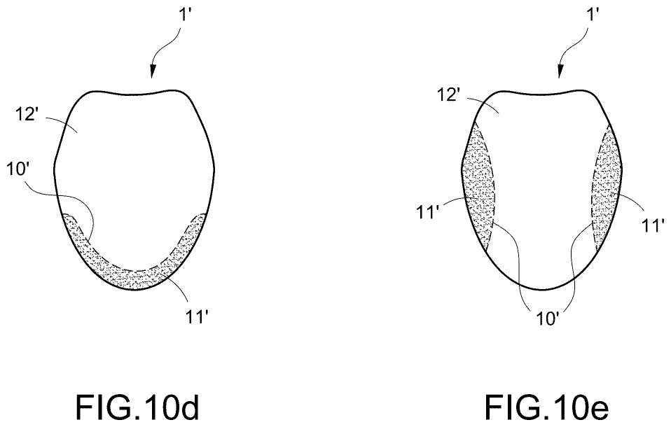

Please also refer to FIG. 10a to FIG. 10e at the same time, where FIG. 10a to FIG. 10e are the schematic diagrams showing a wine tasting carrier of different flavors according to the present disclosure.

In the embodiments presented in FIG. 10a to FIG. 10e, a wine tasting carrier 1′ being shown is manufactured and shaped according to the tongue shape of human. In other words, the size and the shape of the wine tasting carrier 1′ is same as or similar to the size and the shape of the tongue 91 of a human. To say human, it may indicate a common human or a customized human (such as a registered member of a winery), but not limited thereto. Therefore, after grabbing the wine tasting carrier 1′, the taster immediately knows the direction of the wine tasting carrier 1′ and can properly put the wine tasting carrier 1′ into the mouth in a correct direction (i.e., when the wine tasting carrier 1′ is in the mouth, the wine tasting carrier 1′ should overlaps the tongue 91 partially or entirely).

In the embodiments of FIG. 10a through FIG. 10e, the wine tasting carrier 1′ has an original carrier, a flavor carrying region 11′, and a flavourless region 12′, where the flavor carrying region 11′ and the flavourless region 12′ are respectively arranged on the original carrier without overlapping with each other and separated through a visible or invisible boundary line 10′. For example, the present disclosure may form the boundary line 10′ on the surface of the wine tasting carrier 1′ through a solid line(s) or dotted lines, so as to divide the surface of the wine tasting carrier 1′ (i.e., the surface of the original carrier) into the flavor carrying region 11′ and the flavourless region 12′, and the flavor carrying region 11′ does not overlap the flavourless region 12′.

It should be mentioned that the original carrier can be a rice paper membrane that provides no special flavor. The original carrier is manufactured and provided in the shape of human's tongue. During the production, one or two boundary lines 10′ are set on the original carrier to divide the surface of the original carrier into the flavor carrying region 11′ and the flavourless region 12′. The wine tasting carrier 1′ further includes one or more producing materials which brings a specific flavor or aroma. In the next production procedure, a corresponding producing material(s) is attached onto the flavor carrying region 11′ at a corresponding position of the original carrier. After the flavor carrying region 11′ of the original carrier absorbs the producing material(s), the original carrier may be transformed into the wine tasting carrier 1′ having the flavor carrying region 11′ and the flavourless region 12′. In the embodiment, the flavourless region 12′ provides same flavor of the original carrier (e.g., the original flavor of the rice paper membrane), and the flavor carrying region 11′ provides another flavor different from the flavor of the flavourless region 12′, and the flavor of the flavor carrying region 11′ is corresponding to one of a plurality of flavors/aromas of a target wine.

In the embodiment of FIG. 10a, the flavor carrying region 11′ is arranged at a tip position of the wine tasting carrier 1′ on one side of the boundary line 10′, while the position of the wine tasting carrier 1′ on the other side of the boundary line 10′ is regarded as the flavourless region 12′. As disclosed above, the taster may feel sweetness of the wine by the tip 911 of the tongue 91. In the embodiment, the wine tasting carrier 1′ shown in FIG. 10a is provided with the producing material(s) corresponding to the sweetness flavor of the target wine attached only on the flavor carrying region 11′ which is corresponding to the tip 911 of the tongue 91, while the flavourless region 12′ remains no flavor as the original carrier. In conclusion, after putting the wine tasting carrier 1′ of FIG. 10a into the mouth in the right direction, the taster can feel the sweetness flavor (such as dry, off dry, medium dry, medium sweet, sweet, or luscious) of the target wine by the tip 911 of the tongue 91 and get to know the sweetness flavor of the target wine. Therefore, when directly drinking the target wine, the taster may easily understand the sweetness flavor of the target wine.

In the embodiment of FIG. 10b, the flavor carrying region 11′ is arranged at a middle position of the wine tasting carrier 1′ within an area encompassed by two boundary lines 10′, while two positions of the wine tasting carrier 1′ on the other side of each of the two boundary lines 10′ are regarded as the flavourless regions 12′. According to retronasal olfaction, the taster may feel the primary aroma and/or the secondary aroma of the target wine by the middle position 912 of the tongue 91. In the embodiment, the wine tasting carrier 1′ shown in FIG. 10b is provided with the producing material(s) corresponding to the primary aroma and/or the secondary aroma of the target wine attached only on the flavor carrying region 11′ which is corresponding to the middle position 912 of the tongue 91, while the flavourless regions 12′ remain no flavor as the original carrier. In conclusion, after putting the wine tasting carrier 1′ of FIG. 10b into the mouth in the right direction, the taster can feel the primary aroma (such as cherry, cassis, or violet) of the target wine and/or the secondary aroma (such as vanilla, tobacco, or tea) of the target wine by the middle position 912 of the tongue 91 and get to know the primary aroma and/or the secondary aroma of the target wine. Therefore, when directly drinking the target wine, the taster may easily understand the primary aroma and/or secondary aroma of the target wine.

In the embodiment of FIG. 10c, the flavor carrying region 11′ is arranged at a rear position of the wine tasting carrier 1′ on one side of the boundary line 10′, while the position of the wine tasting carrier 1′ on the other side of the boundary line 10′ is regarded as the flavourless region 12′. According to retronasal olfaction, the taster may feel the secondary aroma and/or the tertiary aroma of the target wine by the rear position 913 of the tongue 91. In the embodiment, the wine tasting carrier 1′ shown in FIG. 10c is provided with the producing material(s) corresponding to the secondary aroma and/or the tertiary aroma of the target wine attached only on the flavor carrying region 11′ which is corresponding to the rear position 913 of the tongue 91, while the flavourless region 12′ remains no flavor as the original carrier. In conclusion, after putting the wine tasting carrier 1′ of FIG. 10c into the mouth in the right direction, the taster can feel the secondary aroma (such as vanilla, tobacco, or tea) of the target wine and/or the tertiary aroma (such as mushroom, chocolate, or quince) of the target wine by the rear position 913 of the tongue 91 and get to know the secondary aroma and/or the tertiary aromas of the target wine. Therefore, when directly drinking the target wine, the taster may easily understand the secondary aroma and/or tertiary aroma of the target wine.

In the embodiment of FIG. 10d, the flavor carrying region 11′ is arranged at a circular area from the front to the sides of the wine tasting carrier 1′ on one side of the boundary line 10′, while the position of the wine tasting carrier 1′ on the other side of the boundary line 10′ is regarded as the flavourless region 12′. As disclosed above, the taster may feel tannin of the target wine by the circular area 914 from the front to the sides of the tongue 91. In the embodiment, the wine tasting carrier 1′ shown in FIG. Od is provided with the producing material(s) corresponding to the tannin flavor of the target wine attached only on the flavor carrying region 11′ which is corresponding to the circular area 914 from the front to the sides of the tongue 91, while the flavourless region 12′ remains no flavor as the original carrier. In conclusion, after putting the wine tasting carrier 1′ of FIG. 10d into the mouth in the right direction, the taster can feel the tannin flavor (such as low, medium(−), medium, medium(+), or high) of the target wine by the circular area 914 from the front to the sides of the tongue 91 and get to know the tannin flavor of the target wine. Therefore, when directly drinking the target wine, the taster may easily understand the tannin flavor of the target wine.

In the embodiment of FIG. 10e, the flavor carrying regions 11′ is arranged at two separated sides of the wine tasting carrier 1′ respectively on one side of two boundary lines 10′, while the position of the wine tasting carrier 1′ within an area encompassed by the two boundary lines 10′ is regarded as the flavourless region 12′. As disclosed above, the taster may feel acidity of the target wine by the two separated sides 915 of the tongue 91. In the embodiment, the wine tasting carrier 1′ shown in FIG. 10e is provided with the producing material(s) corresponding to the acidity flavor of the target wine attached only on the two flavor carrying regions 11′ which are corresponding to the two separated sides 915 of the tongue 91, while the flavourless region 12′ remains no flavor as the original carrier. In conclusion, after putting the wine tasting carrier 1′ of FIG. 10e into the mouth in the right direction, the taster can feel the acidity flavor (such as low, medium(−), medium, medium(+), or high) of the target wine by the two separated sides 915 of the tongue 91 and get to know the acidity flavor of the target wine. Therefore, when directly drinking the target wine, the taster may easily understand the acidity flavor of the target wine.

When drinking the wine, the entire tongue will directly contact the wine, so that multiple flavors/aromas of the wine may be released simultaneously. Therefore, it is hard for the taster to distinguish different flavors/aromas released by the wine to understand each of the flavors/aromas. To resolve the difficulty, the present disclosure provide a carrier set having multiple wine tasting carriers 1′, where each of the wine tasting carriers 1′ only bring one flavor/aroma at the flavor carrying region 11′ corresponding to a certain position of the taster's tongue 91.

When putting the wine tasting carrier 1′ into the mouth, the taster may only feel the corresponding flavor/aroma through tasting the producing material(s) attached on the flavor carrying region(s) 11′ of the wine tasting carrier 1′ at a specific position. More specifically, when the taster holds the wine tasting carrier 1′ in the mouth, the producing material(s) attached on the flavor carrying region(s) 11′ at the specific position may be decomposed by the taster's saliva, so the taster may taste the flavor/aroma presented by the producing material(s) on the flavor carrying region(s) 11′ by the specific position of the tongue 91. As a result, the slower the producing material(s) are decomposed, the longer the taster will be able to taste the flavor/aroma. In this way, the taster has enough time to understand each specific flavor/aroma of the target wine through putting each of the wine tasting carriers 1′ as shown from FIG. 10a through FIG. 10e one after another.

By reducing the area of contact between the wine tasting carrier 1′ and the taster's tongue, the decomposed time of the producing material(s) attached on the wine tasting carrier 1′ can be slowed down and the tasting time of the taster can be prolonged.

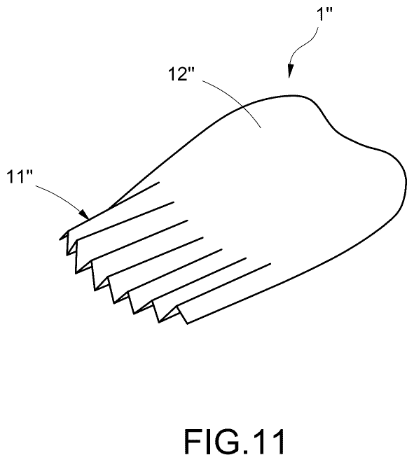

Please see FIG. 11, which is a schematic diagram of wine tasting carrier of another embodiment according to the present disclosure. FIG. 11 shows another wine tasting carrier 1″. The difference between the wine tasting carrier 1′ of FIG. 10a through FIG. 10e and the wine tasting carrier 1″ of FIG. 11 is that, the wine tasting carrier 1″ in the embodiment of FIG. 11 includes the original carrier, a flavor carrying region 11 “, and a flavourless region 12”, where the flavor carrying region 11″ is constructed in a three-dimensional wave shape or a three-dimensional wrinkle shape and the flavourless region 12″ remains planar. In the embodiment, the flavor carrying region 11″ and the flavourless region 12″ are separated through a boundary line(s) similar to the disclosure of FIG. 10a through FIG. 10e, detailed description is omitted here.

By constructing the flavor carrying region 11″ as the three-dimensional wave shape or the three-dimensional wrinkle shape, the producing material(s) attached on the flavor carrying region 11″ of the wine tasting carrier 1″ will be slowly decomposed in the taster's mouth due to the reduced area of contact, so that the taster may have enough time to experience the flavor/aroma of the target wine corresponding to the wine tasting carrier 1″ after putting each wine tasting carrier 1″ into the mouse.

As mentioned above, a wine may release different flavors at different time points or different positions in the mouth after drinking. For the taster to experience different flavors/aromas brought by same wine, a carrier set may be corresponding to one wine and includes multiple wine tasting carriers 1′ and/or wine tasting carriers 1″, wherein each of the multiple wine tasting carriers 1′/1″ respectively brings one of the multiple flavors/aromas of the corresponding wine through the producing material(s) attached on the flavor carrying region(s) 11′/11″.

For the sake of understanding, the following description takes the wine tasting carriers 1′ having the flavor carrying region(s) 11′ as shown in FIG. 10a through FIG. 10e as an example, but not limited thereto.

In one embodiment, a carrier set may be produced based on a first target wine and include five wine tasting carriers 1′, wherein the five wine tasting carriers 1′ include a first wine tasting carrier having a first flavor carrying region arranged at the tip position of the first wine tasting carrier (as shown in FIG. 10a) to bring up the sweetness flavor of the first target wine, a second wine tasting carrier having a second flavor carrying region arranged at the middle position of the second wine tasting carrier (as shown in FIG. 10b) to bring up the primary aroma and/or the secondary aroma of the first target wine, a third wine tasting carrier having a third flavor carrying region arranged at the rear position of the third wine tasting carrier (as shown in FIG. 10c) to bring up the secondary aroma and/or the tertiary aroma of the first target wine, a fourth wine tasting carrier having a fourth flavor carrying region at the circular area from the front to the sides of the fourth wine tasting carrier (as shown in FIG. 10d) to bring up the tannin flavor of the first target wine, and a fifth wine tasting carrier having a fifth flavor carrying regions at two separated sides of the fifth wine tasting carrier (as shown in FIG. 10e) to bring up the acidity flavor of the first target wine.

By purchasing and eating the multiple wine tasting carriers 1′ included in the carrier set corresponding to the first target wine, the taster is easily understanding each flavor/aroma that may be released by the first target wine without actually drinking the first target wine.

In another embodiment, the number of the wine tasting carriers 1′ included in the carrier set is not limited. For example, a carrier set can include three first wine tasting carriers of FIG. 10a, five second wine tasting carriers of FIG. 10b, ten third wine tasting carriers of FIG. 10c, and so on. In this case, the taster can try each wine tasting carrier 1′ more than one time, so the taster can have enough chance to get to understand the exact flavor/aroma of the target wine.

For the sake of simplicity, the following descriptions and examples are disclosed and discussed mainly based on the wine tasting carrier 1 as shown in FIG. 1, but not limited thereto. All the various embodiments are also proper to be facilitated to the wine tasting carriers 1′ of FIG. 10a through FIG. 10e as well as the wine tasting carrier 1″ of FIG. 11, detailed description will be omitted in the following paragraphs.

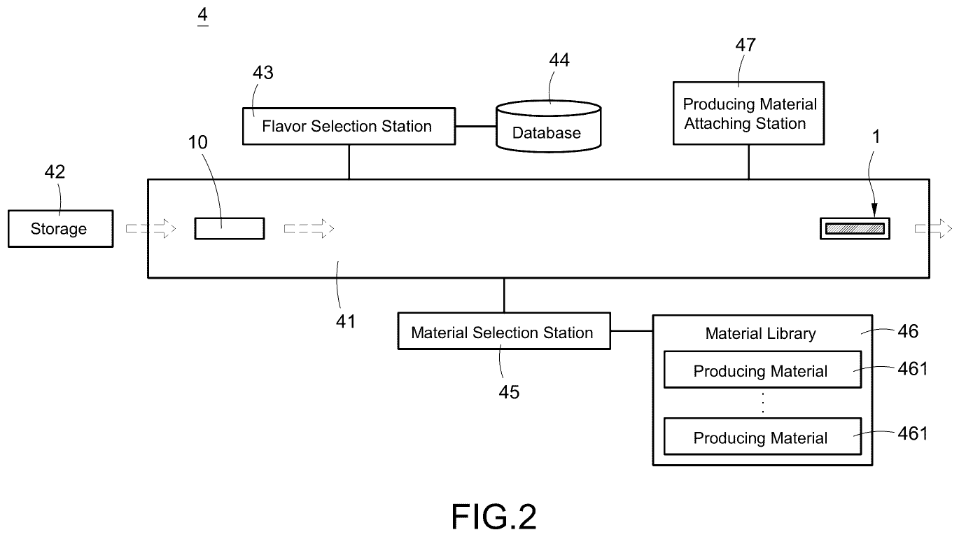

Please refer to FIG. 2, which is a schematic diagram showing a production line of the wine tasting carrier of an embodiment according to the present disclosure. FIG. 2 discloses a specific example of a production line 4 for producing the wine tasting carrier 1. As shown in FIG. 2, the production line 4 may include a conveyor 41, a storage 42, a flavor selection station 43, a database 44, a material selection station 45, a material library 46, and a producing material attaching station 47.

The storage 42 stores a plurality of original carrier 10. When producing the wine tasting carrier 1, the original carrier 10 stored in the storage 42 is put onto the conveyor 41 manually by the operator or automatically by the system, and the conveyor 41 transports the original carrier 10 to move to each station for being processed. In one embodiment, the original carrier 10 is an edible carrier such as a rice paper membrane, but not limited thereto.

The flavor selection station 43 is connected with the database 44, wherein the database 44 records multiple flavor information respectively corresponding to different wines. For example, the database 44 may create different folders for different wines, and each of the folders records information of one or more flavors related to a corresponding wine.

In the present disclosure, the flavor selection station 43 may be controlled manually by the operator or automatically by the system, so as to select one target wine 2 from the multiple wines recorded in the database 44. After the target wine 2 is selected, the flavor selection station 43 inquires the database 44 again in accordance with the selected target wine 2, and selects and reads one of the multiple flavors that are corresponding to the target wine 2 from the database 44.

In a first embodiment, the flavor selected and read by the flavor selection station 43 is a single flavor brought by the target wine 2 itself. In a second embodiment, the flavor selected and read by the flavor selection station 43 is a single flavor brought by the target wine 2 at a specific time point or at a specific position in the mouth after drinking. In a third embodiment, the flavor selected and read by the flavor selection station 43 is a flavor of a dish that is best pairing with the target wine 2.

In particular, the database 44 may create at least three folders for each wine. According to the three embodiments mentioned above, the three folders may be used to respectively record the information of three different categories of flavor corresponding to a wine. However, the above descriptions are only few embodiments of the present disclosure, but not limited thereto.

As mentioned above, when the original carrier 10 is moved by the conveyor 41 to the flavor selection station 43, the flavor selection station 43 may select a flavor that needs to be attached to the original carrier 10 through the aforementioned procedure.

The material selection station 45 is connected with the material library 46, wherein the material library 46 stores multiple producing materials 461 that are corresponding to different flavors recorded in the database 44. For an example, if thirty flavors are recorded in the database 44 (i.e., the database 44 stores thirty sets of flavor information), the material library 46 may store multiple producing materials 461 that may be used to provide the thirty flavors. In one embodiment, one producing material 461 may directly provide one of the recorded flavors. In another embodiment, each of the recorded flavor may be produced and provided by the production line 4 through mixing multiple producing materials 461. However, the above descriptions are only few embodiments of the present disclosure, but not limited thereto.

In particular, the material selection station 45 may communicate with the flavor selection station 43 through a wired manner or a wireless manner, and the material selection station 45 may obtain the information related to the selected flavor (such as a flavor of woody, a flavor of earthy, or a flavor of chemical, etc.) from the flavor selection station 43. Next, the material selection station 45 inquires and controls the material library 46 in accordance with the obtained information, so as to retrieve, from the material library 46, one or more of the producing materials 461 that may be used to provide the selected flavor.

In one embodiment, the producing materials 461 stored in the material library 46 are, for example but not limited to, liquid materials. The material selection station 45 may directly provide the selected flavor through a single producing material 461, or provide the selected flavor through a mixture of multiple producing materials 461.

When the original carrier 10 is moved by the conveyor 41 to the material selection station 45, the material selection station 45 may obtain a single producing material 461 or multiple producing material 461 which are used to provide the selected signal flavor.

The producing material attaching station 47 is located at a producing zone of the production line 4, and the producing material attaching station 47 may obtain the one or more producing materials 461 corresponding to the selected flavor from the material selection station 45 or the material library 46. When the original carrier 10 is moved by the conveyor 41 to the producing material attaching station 47, the producing material attaching station 47 attaches the one or more producing materials 461 to the original carrier 10 (for example, attaches the one or more producing materials 461 to the flavor carrying region 11′ or 11″ of the original carrier as shown in FIG. 10a through FIG. 10e and FIG. 11). The flavor provided by the producing material 461 may then attach to the original carrier 10; thereby, transforming the original carrier 10 that does not have any special flavor into the wine tasting carrier 1 that carries the selected flavor.

In a first embodiment, the producing material 461 is a liquid material and stored in a capsule (not shown). In the embodiment, the producing material attaching station 47 obtains the capsule that stores the producing material 461 related to the selected flavor from the material selection station 45 or the material library 46. When the original carrier is moved by the conveyor 41 to the producing material attaching station 47, the producing material attaching station 47 controls a specific mechanism (not shown) to poke or to open the capsule, so the producing material 461 in the capsule may drip from the capsule to (the flavor carrying region of) the original carrier 10 to be absorbed by the surface of the original carrier 10. Therefore, the original carrier 10 may be transformed into the wine tasting carrier 1 having the flavor of the producing material 461 (through the flavor carrying region of the wine tasting carrier 1).

In a second embodiment, the producing material 461 is a liquid material, and the material library 46 stores multiple producing materials 461 through tanks. In the embodiment, the producing material attaching station 47 may control the material library 46. When the original carrier 10 is moved by the conveyor 41 to the producing material attaching station 47, the producing material attaching station 47 controls the material library 46 in accordance with the selection made by the material selection station 45, and the producing material 461 stored in a designated tank may drip onto (the flavor carrying region of) the original carrier 10 through a pipe (not shown) and be absorbed by the surface of the original carrier 10. Therefore, the original carrier 10 may be transformed into the wine tasting carrier 1 having the flavor of the producing material 461 (through the flavor carrying region of the wine tasting carrier 1).

In a third embodiment, the producing material 461 is a liquid material, and the material library 46 stores multiple producing materials 461 through tanks. In the embodiment, the producing material attaching station 47 includes a heating unit (not shown).

When the original carrier 10 is moved by the conveyor 41 to the producing material attaching station 47, the producing material attaching station 47 controls the material library 46 in accordance with the selection made by the material selection station 45, and the producing material 461 stored in a designated tank may flow into the producing material attaching station 47 through a pipe (not shown). Next, the producing material attaching station 47 controls the heating unit to heat the producing material 461 to transform the producing material 461 into gas form. The producing material 461 as gas form may then attach to the original carrier 10 and be absorbed by the original carrier 10. Therefore, the original carrier 10 may be transformed into the wine tasting carrier 1 having the flavor of the producing material 461.

However, the above descriptions are only few embodiments of the present disclosure, but the producing approach of the wine tasting carrier 1 of the present disclosure is not limited thereto.

It should be mentioned that even if the producing material 461 may be absorbed by the original carrier 10 during the producing procedure; however, the producing material 461 may volatilize in the air when contacting with the air. Therefore, the flavor brought by the producing material 461 may spill out, and the spilled flavor may then affect the user experience. For example, if the wine taster stores or brings multiple wine tasting carriers 1, the flavor spilled from one of the wine tasting carriers 1 may affect the flavor of the others.

In one embodiment, the producing material attaching station 47 may arrange a sealing film on the original carrier 10 after attaching the producing material 461 onto the original carrier 10. The sealing film may be made of edible and dissolvable material, and the sealing film sticks on the surface of the original carrier 10 that absorbs the producing material 461. After the wine tasting carrier 1 is produced, the producing material 461 may be sealed by the sealing film, and the flavor brought by the producing material 461 may be completely reserved in the wine tasting carrier 1.

As mentioned above, the sealing film is made of edible and dissolvable material, which may not affect the wine taster in using the wine tasting carrier 1.

However, the above description is only one of the embodiments of the present disclosure, but the sealing film is not an essential component in producing the wine tasting carrier 1.

As shown in FIG. 2, after the original carrier 10 stored in the storage 42 is put on the conveyor 41, the original carrier 10 may be moved through the flavor selection station 43 and the material selection station 45 and then entered the producing material attaching station 47. The producing material attaching station 47 processes the original carrier 10 in accordance with the selections made by the flavor selection station 43 and the material selection station 45, so as to generate the wine tasting carrier 1 being attached with the selected flavor. After that, the production line 4 may output the wine tasting carrier 1 for the wine taster to use.

As mentioned above, each wine may carry multiple flavors. The production line 4 of the present disclosure may process multiple original carriers 10 on the conveyor 41 accordingly in an order based on the selected target wine 2, so as to generate multiple wine tasting carriers 1 that are respectively corresponding to different flavors of the target wine 2.

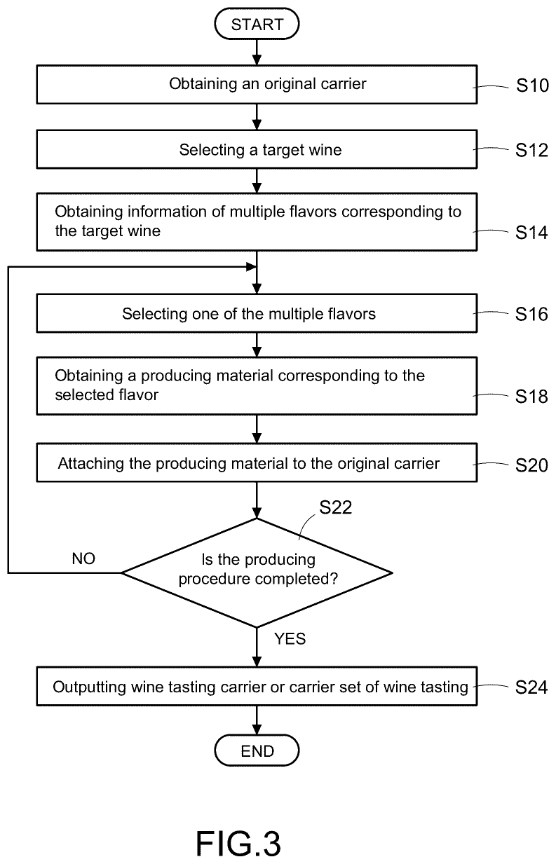

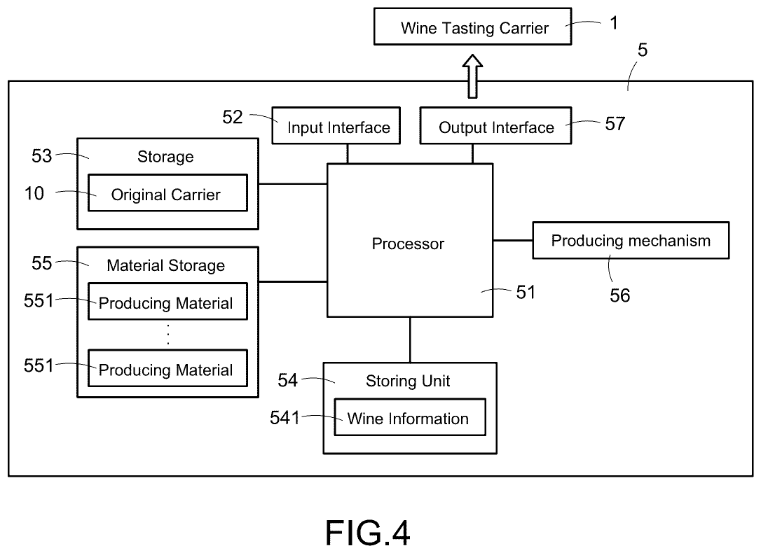

Please refer to FIG. 3, which is a flowchart of a producing method of an embodiment according to the present disclosure. FIG. 3 discloses a producing method of the wine tasting carrier of the present disclosure, wherein the producing method may be applied to the production line 4 as shown in FIG. 2 and to a producing apparatus (such as the producing apparatus 5 shown in FIG. 4) that is made and improved based on the production line 4. Also, the producing method of the present disclosure may be applied in an environment that produces the wine tasting carriers by human labor, but not limited to.

As shown in FIG. 3, to use the producing method of the present disclosure, an original carrier 10 without any special flavor should be obtained by the production line 4, the producing apparatus 5, or the user (step S10). In one embodiment, the original carrier 10 may be an edible carrier (i.e., a carrier that is dissolvable in the mouth), such as a rice paper membrane, but not limited.

In another embodiment, the original carrier 10 is made of a material that is non-dissolvable in the mouth. In the embodiment, when the wine taster puts the wine tasting carrier 1 into the mouth, the producing material 461 attached on the wine tasting carrier 1 may be decomposed by saliva, and then the wine taster may taste the flavor provided by the decomposed producing material 461 in the mouth.

Next, a target wine 2 corresponding to the wine tasting carrier 1 (or the carrier set) that the user, the production line 4, or the producing apparatus 5 wants to produce should be selected (step S12). For example, the target wine 2 may be a specific whisky or a specific wine that is made of a specific winery or a specific year, but not limited thereto.

In the present disclosure, the user may pre-analyze the target wine 2 and record the information related to the one or more flavors corresponding to the target wine 2 to a database. After the step S12, the production line 4, the producing apparatus 5, or the user may obtain the information of the multiple flavors corresponding to the target wine 2 from the database (step S14), and select one of the multiple flavors in accordance with the information being read (step S16). Next, the production line 4, the producing apparatus 5, or the user may obtain the producing material(s) 461 corresponding to the selected flavor in accordance with the selection made from the step S16 (step S18).

In a first embodiment, the production line 4, the producing apparatus 5, or the user may select, in the step S16, a single flavor brought by the wine target 2 itself. For example, the selected flavor may be a flavor of fruity or a flavor of floral, etc. In a second embodiment, the production line 4, the producing apparatus 5, or the user may select, in the step S16, a single flavor that may be brought by the target wine 2 at a specific time point or at a specific position in the mouth after drinking. For example, the selected flavor may be a flavor of a middle section or a flavor of an aftertaste section, etc. In a third embodiment, the production line 4, the producing apparatus 5, or the user may select, in the step S16, a flavor corresponding to a dish (such as steak) that is most pairing with the target wine 2. However, the above descriptions are only few embodiments of the present disclosure, but not limited thereto.

Next, the production line 4, the producing apparatus 5, or the user may attach the one or more producing materials 461 obtained from the step S18 to (the flavor carrying region of) the original carrier 10, so as to transform the original carrier 10 into the wine tasting carrier 1 having the flavor provided by the producing material(s) 461 (step S20).

In one embodiment, the production line 4, the producing apparatus 5, or the user may further arrange a sealing film on the original carrier 10 in the step S18. The sealing film is made of an edible and dissolvable material and is used to stick to the surface of the original carrier 10 to seal the producing material 461 in the original carrier 10. Therefore, the flavor brought by the producing material 461 on the wine tasting carrier 1 may be prevented from spilling out to the air.

After the step S20, the production line 4, the producing apparatus 5, or the user may determine whether the producing procedure of the wine tasting carrier 1 is completed (step S22). For example, if the target wine 2 carries ten flavors, the flow shown in FIG. 3 should be executed ten times to sequentially produce ten wine tasting carriers 1 that are respectively attached with one of the ten flavors. Then, a carrier set for wine tasting that is corresponding to the target wine 2 may be constituted by the ten wine tasting carriers 1.

In another embodiment, the production line 4, the producing apparatus 5, and the user may physically divide one original carrier 10 into multiple areas and respectively attach the producing materials 461 that are corresponding to different flavors of same target wine 2 onto different areas (detailed described in the following). In the embodiment, the carrier set corresponding to the target wine 2 may be directly constituted by the multiple areas of a single wine tasting carrier 1. In other words, it is unnecessary for the carrier set of the present disclosure to involve multiple separated wine tasting carriers 1.

As disclosed in FIG. 3, if the producing procedure is determined to be unfinished in the step S22, the production line 4, the producing apparatus 5, or the user returns to the step S16 to select the next flavor of the target wine 2 and to produce the next wine tasting carrier 1 accordingly.

If the producing procedure is determined to be finished in the step S22, the production line 4, the producing apparatus 5, or the user may output the wine tasting carrier 1 or the carrier set being produced completely (step S24), and then terminate the producing method of the present disclosure.

As discussed above, in addition to the production line 4, the present disclosure further discloses a producing apparatus 5 for producing the wine tasting carrier 1. In particular, the producing apparatus 5 of the present disclosure is made of improving each station of the production line 4 and each step of the producing method and implementing all the producing procedure of the wine tasting carrier 1 into a single machine. The user may place the producing apparatus 5 at different wine tasting occasions (such as a winery or a restaurant, etc.). When a user wants to taste a specific flavor, the producing apparatus may be operated to select a target wine 2 and a target flavor and produce a wine tasting carrier 1 correspondingly in real-time.

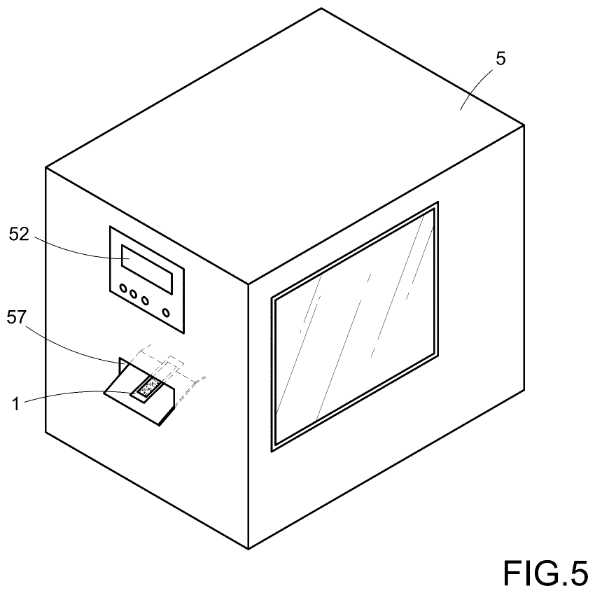

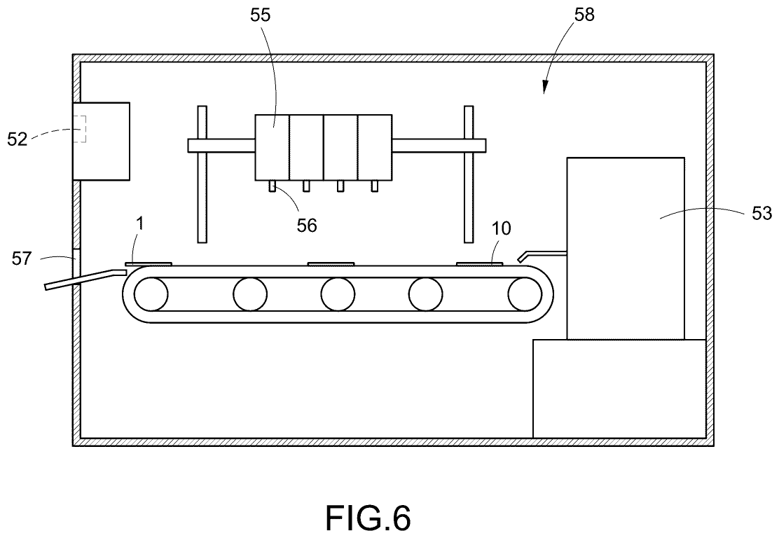

Please refer to FIG. 4, FIG. 5, and FIG. 6 at the same time, wherein FIG. 4 is a block diagram of a producing apparatus of an embodiment according to the present disclosure, FIG. 5 is a schematic diagram showing a producing apparatus of a first embodiment according to the present disclosure, and FIG. 6 is a schematic diagram showing the producing apparatus of a second embodiment according to the present disclosure.

As disclosed in FIG. 4, the producing apparatus 5 at least includes a processor 51, an input interface 52, a storage 53, a storing unit 54, a material storage 55, a producing mechanism 56, and an output interface 57, wherein the input interface 52, the storage 53, the storing unit 54, the material storage 55, and the producing mechanism 56 are electrically connected with the processor 51.

A plurality of original carriers 10 are stacked in the storage 53 for the producing apparatus 5 to process. The storing unit 54 records a plurality of wine information 541, wherein each of the wine information 541 records an information related to multiple flavors corresponding to one wine, such as the multiple flavors brought by the wine itself, the multiple flavors brought by the wine at different time points or at different positions in the mouth after drinking, or the multiple flavors of dishes that are pairing with the wine, but not limited thereto.

To use the producing apparatus 5 of the present disclosure, the user needs to pre-analyze one or more wines 2 to extract the flavors from each wine 2, and the user needs to record the information related to these flavors into the storing unit 54.

The material storage 55 stores multiple producing materials 551 that are corresponding to these flavors. In particular, after a specific wine is analyzed, the user may record the information related to the multiple flavors of this wine into the storing unit 54, and the user may obtain or create the producing materials 551 that may be used to provide these flavors through experiments. Therefore, the user may store the producing materials 551 in the material storage 55. In one embodiment, the producing materials 551 are liquid materials, and the material storage 55 has multiple tanks to respectively store each of the liquid materials.

The input interface 52 may be a human machine interface (HMI), such as a touch screen, a combination of monitor and keyboard, or an interface of voice input, etc., but not limited. When using the producing apparatus 5, the producing apparatus 5 may display the name or the introduction of one or more supportable wines on the input interface 52, and the user may operate the input interface 52 to select one of the displayed wines to be the target wine 2.

After the target wine 2 is selected, the processor 51 inquires the storing unit 54 in accordance with the selection to read the wine information 541 corresponding to the selected target wine 2. Also, the producing apparatus 5 displays the wine information 541 on the input interface 52. Next, the user may again operate the input interface 52 to select one of the flavors included in the wine information 541 being displayed.

After the selection made by the user, the processor 51 controls the storage 53 to transport an original carrier 10 through a transportation mechanism (not shown) to a producing space 58 in the producing apparatus 5. In addition, the processor 51 sends a control command to the material storage 55 correspondingly in accordance with the flavor selected by the user, so that the material storage 55 transports (through the transportation mechanism) the producing material(s) 551 corresponding to the selected flavor to the producing space 58.

Next, the processor 51 controls the producing mechanism 56 to operate in the producing space 58 to attach the producing material 551 onto (the flavor carrying region of) the original carrier 10. Therefore, the original carrier 10 may absorb the producing material 551, and the original carrier 10 may be transformed into the wine tasting carrier 1 having the selected flavor (through the flavor carrying region of the wine tasting carrier 1).

After the producing material 551 is attached, the producing mechanism 56 may further stick a sealing film on the original carrier 10, wherein the sealing film is made of edible and dissolvable material. The sealing film stuck on the original carrier 10 may seal the producing material 461 in the original carrier 10, so as to prevent the flavor of the producing material 461 from spilling out to the air.

Next, the processor 51 may control the output interface 57 (such as an opening) to output the wine tasting carrier 1 that is produced completely for the wine taster to taste.

In a first embodiment, the producing material 551 is stored in a capsule (not shown). The material storage 55 stores multiple capsules, each of which accommodates different producing material 551. In the embodiment, the processor 51 controls the material storage 55 to transport a capsule corresponding to the selected flavor to the producing space 58 and controls the producing mechanism 56 to stab the capsule in the producing space 58. Therefore, the producing material 551 accommodated in the capsule may drip on the surface of (the flavor carrying region of) the original carrier 10 for the original carrier 10 to absorb. Therefore, the original carrier 10 may be transformed into a wine tasting carrier 1 having the selected flavor (through the flavor carrying region of the wine tasting carrier 1).

In a second embodiment, the material storage 55 may store the producing material 551 (which is a liquid material) in one of multiple tanks. In the embodiment, the processor 51 controls the producing mechanism 56 to make the producing material 551 corresponding to the selected flavor flowing through a pipe into the producing space 58, so that the producing material 551 may directly drip on (the flavor carrying region of) the original carrier 10 for the original carrier 10 to absorb. Therefore, the original carrier may be transformed into a wine tasting carrier 1 having the selected flavor (through the flavor carrying region of the wine tasting carrier 1).

In a third embodiment, the material storage 55 stores the producing material 551 (which is a liquid material) in one of multiple tanks. In the embodiment, the producing mechanism 56 is a heating unit arranged inside or around the producing space 58. In this embodiment, the processor 51 controls the material storage 55 to transport the producing material 551 corresponding to the selected flavor to the producing mechanism 56, and control the producing mechanism 56 to start heating to transform the liquid producing material 551 in the producing space 58 into gas producing material 551. The gas producing material 551 in the producing space 58 may encompass the original carrier 10 and be absorbed by the original carrier 10. Therefore, the original carrier 10 may be transformed into a wine tasting carrier 1 having the selected flavor.

However, the above descriptions are only few embodiments of the present disclosure, but not limited thereto.

It should be mentioned that the producing apparatus 5 of the present disclosure may connect with a user's mobile device through a wireless transmission interface (not shown). Therefore, the user may operate the producing apparatus 5 through a wireless manner.

For example, in a crowded wine tasting occasion, the wine taster may connect to the producing apparatus 5 by using the mobile device, so as to obtain the information related to the multiple wines supportable to the producing apparatus 5. The wine taster may directly select a target wine or a demanded flavor on the mobile device. After the selection is made, the producing apparatus 5 may control each of the components based on the selection of the wine taster, so as to produce a wine tasting carrier 1 or a carrier set for wine tasting having the demanded flavor(s) immediately, and then provide the wine tasting carrier 1 or the carrier set to the wine taster through the output interface 57.

In the aforementioned embodiment, the user may control the producing apparatus through his own mobile device, so it is unnecessary for the producing apparatus 5 to arrange the input interface 52. Furthermore, based on the using flexibility and extension convenience, the producing apparatus 5 of the present disclosure may store the information related to the flavors and the wines on a cloud server (not shown) and read the information correspondingly from the cloud server when the wine tasting carrier 1 needs to be produced. Therefore, it is unnecessary for the producing apparatus 5 to arrange the storing unit 54.

According to the size of the producing apparatus 5 as well as the occasion for using the producing apparatus 5, the present disclosure defines the producing apparatus 5 as a large producing apparatus and a portable producing apparatus. The detailed description will be provided in the following.

The large producing apparatus may support more categories of wines; therefore, more types and quantities of producing materials 551 should be stored in the large producing apparatus and it enlarges the size of the producing apparatus. As a result, the large producing apparatus is barely moved and suitable for being placed in the winery or the wine stores (or the liquor stores).

In particular, this kind of large producing apparatus may record and produce all flavor of all wine that is provided or sold at the place where the producing apparatus is placed. When the wine taster goes to the place for wine tasting, learning, or purchasing, the large producing apparatus may be operated to produce the wine tasting carrier 1 (or the carrier set) immediately for the wine taster to easily understand the wine(s) that he is going to drink or purchase.

On the contrary, the portable producing apparatus may support less categories of wines in comparison with the large producing apparatus; therefore, less types and quantities of producing materials 551 need to be stored in the portable producing apparatus. The portable producing apparatus may have a smaller size accordingly. Comparing to the large producing apparatus, the portable producing apparatus is easily moved and is suitable to be brought to different wine tasting occasions.

In particular, this kind of portable producing apparatus may be used to record and produce, for example but not limited to: (1) multiple flavors brought by a single wine itself, (2) a flavor of dish that is pairing with a single wine; or (3) same type of flavors brought by different wines (for example, different flavors of smoky brought by different wines). However, the above descriptions are only few embodiments of the present disclosure, but not limited thereto. In the present disclosure, the wine taster may bring the portable producing apparatus to a wine tasting occasion that is held with a specific topic or a specific purpose, so as to assist the event to process and to increase the interesting and the profession of the wine tasting occasion.

As mentioned above, a wine itself may bring multiple flavors (such as a flavor of fruity or a flavor of floral, etc.), or the wine may bring different flavors (such as a flavor of entrance section, a flavor of middle section, or a flavor of aftertaste section, etc.) at different time points or at different positions in the mouth after drinking. The producing method and the producing apparatus of the present disclosure are used to produce multiple wine tasting carriers 1 in accordance with multiple flavors that are corresponding to one wine, so that a carrier set for wine tasting may be constituted to correspond to all the flavors of this wine. However, if the volume of the original carrier is large or long enough and the original carrier 10 includes multiple areas thereon, the producing method and the producing apparatus of the present disclosure may also use a single original carrier 10 to directly implement a carrier set for wine tasting.

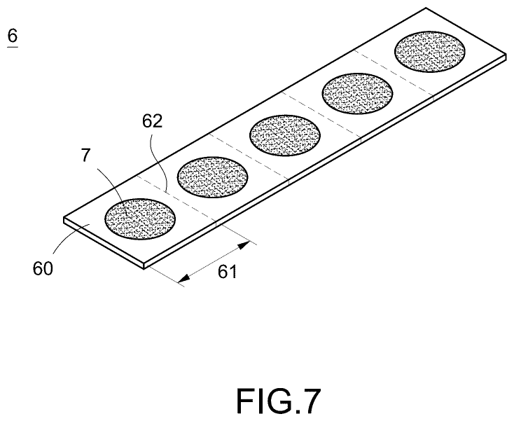

Please refer to FIG. 7, which is a schematic diagram showing the wine tasting carrier of a second embodiment according to the present disclosure. FIG. 7 discloses another wine tasting carrier 6 of the present disclosure. In the embodiment of FIG. 7, the wine tasting carrier 6 includes an original carrier 60. The original carrier 60 is physically divided into two or more than two tasting areas 61.

When producing the wine tasting carrier 6, the producing method or the producing apparatus of the present disclosure may attach different flavors 7 corresponding to the target wine 2 respectively onto different tasting areas 61 of the original carrier 60. Therefore, the original carrier 60 may be transformed into a wine tasting carrier 6 having multiple flavors 7 corresponding to the target wine 2. For example, the producing method or the producing apparatus of the present disclosure may respectively drip different producing materials to different tasting areas 61 of the original carrier 60, so as to generate a demanded wine tasting carrier 6.

The original carrier 60 may be an edible carrier, such as a rice paper membrane, but not limited. In one embodiment, the arrangement order of the multiple flavors 7 on the wine tasting carrier 6 may be corresponding to the introduction order made by a host aimed at the target wine 2. For example, if a host in a wine tasting occasion wants to introduce a flavor of fruity, a flavor of floral, and a flavor of caramel in an order that are brought by a target wine 2, the wine tasting carrier 6 corresponding to the target wine 2 may be attached with a producing material for the flavor of fruity, a producing material for the flavor of floral, and a producing material for the flavor of caramel respectively on a first tasting area, a second tasting area, and a third tasting area that are sequentially arranged from an front end to a rear end of the wine tasting carrier 6.

For another example, if the host in the wine tasting occasion wants to introduce multiple flavors respectively brought by a target wine 2 at an entrance section, at a middle section, a closing section, and an aftertaste section after drinking, the wine tasting carrier 6 corresponding to the target wine 2 may be attached with a producing material for the flavor of the entrance section, a producing material for the flavor of the middle section, a producing material for the flavor of the closing section, and a producing material for the flavor of the aftertaste section respectively on a first tasting area, a second tasting area, a third tasting area, and a fourth tasting area that are sequentially arranged from an front end to a rear end of the wine tasting carrier 6.

As mentioned above, the original carrier 60 of the present disclosure is an edible carrier, and the original carrier 60 is dissolvable in the taster's mouth. If a sealing film is stuck on the wine tasting carrier 6, the sealing film should also be made of edible material and should be dissolvable in the mouth.

In the above embodiment, the host may first introduce the flavor of the entrance section of the target wine 2 (i.e., the entrance flavor) because the entrance flavor is the flavor the taster may first taste after drinking the target wine 2, and then the wine taster may put the first tasting area of the wine tasting carrier 6 into the mouth to taste the flavor 7 corresponding the entrance flavor of the target wine 2 after the first tasting area is decomposed by saliva. Then, the host may introduce the flavor of the middle section of the target wine 2 (i.e., the middle flavor) because the middle flavor is the flavor the taster may taste after the entrance flavor passes, and then the wine taster may put the second tasting area of the wine tasting carrier 6 into the mouth to taste the flavor 7 of the middle flavor of the target wine 2 after the second tasting area is decomposed by saliva, and so on.

As disclosed in FIG. 7, in an embodiment, the original carrier 60 may be divided into multiple tasting areas 61 through physical cutting lines 62. For example, the producing method or the producing apparatus 5 of the present disclosure may form the physical cutting lines 62 on the original carrier 60 through piercing holes, so as to divide the original carrier 60 into the multiple tasting areas 61. The existence of the cutting lines 62 reduces the contact area between two adjacent tasting areas 61. When producing the wine tasting carrier 6, the producing material may be prevented from flowing to an adjacent tasting area 61 when being attached to another tasting area 61 and affecting the experience of the taster in tasting the wine tasting carrier 6.

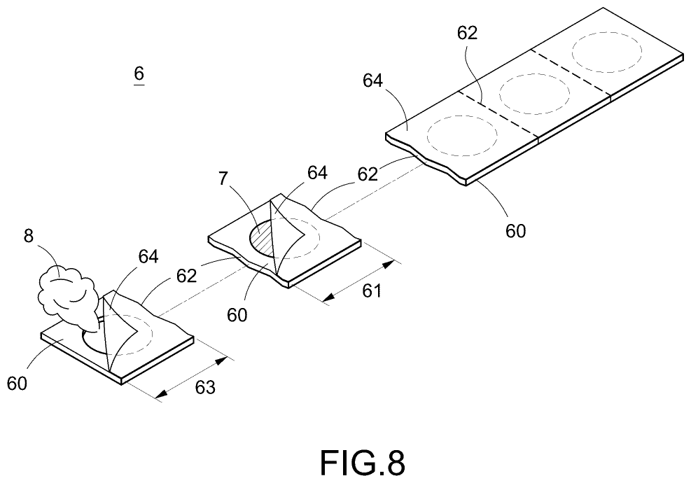

Please refer to FIG. 8, which is a schematic diagram showing the wine tasting carrier of a third embodiment according to the present disclosure. FIG. 8 discloses another wine tasting carrier 6 of the present disclosure. The difference between the embodiment of FIG. 7 and the embodiment of FIG. 8 is that a first tasting area 61 or a last tasting area 61 of the original carrier 60 as shown in FIG. 8 may be arranged as a smelling area 63.

In particular, when producing the wine tasting carrier 6, the producing method or the producing apparatus 5 of the present disclosure may obtain another odor producing material and attach the odor producing material to the smelling area 63. Therefore, the smelling area 63 may spread the corresponding odor needed by the wine taster into the air. In an embodiment, the odor producing material may provide the odor of the target wine 2 itself. In another embodiment, the odor producing material may provide the odor of one of a plurality of flavors brought by the target wine 2, but not limited thereto.

In the embodiment, the odor producing material may be liquid material, gas material, or solid material, but not limited thereto. The producing method or the producing apparatus 5 of the present disclosure may attach the odor producing material to the smelling area 63 and seal the smelling area 63 by using a sealing film 64. In the embodiment, the sealing film 64 may be made of edible material or non-edible material. Also, the sealing film 64 may be dissolvable or non-dissolvable, but not limited.

When using the wine tasting carrier 6, the wine taster may tear the sealing film 64 off the wine tasting carrier 6 for the demanded odor 8 (i.e., the odor provided by the odor producing material) to be released from the smelling area 63. After tearing the sealing film 64 off, the wine taster may smell the odor 8 released from the smelling area 63, and the wine taster may acknowledge the odor of the target wine 2. Next, the wine taster may cut or tear the entire smelling area 63 off the wine tasting carrier 6. Next, along with the host introducing the flavors of the target wine 2, the wine taster may sequentially put each of the tasting areas 61 of the wine tasting carrier 6 into the mouth in a corresponding order. Therefore, the wine taster may taste the flavors of the target wine 2 in the mouth in an order that is corresponding to the introduction.

Through using the wine tasting carrier 6, the wine taster may taste each flavor brought by the target wine 2 through taste sense, and also smell the odor spread by the target wine 2 itself through olfactory sense. Therefore, the wine taster may easily understand the target wine 2, and the pleasure of wine tasting may be improved also.

As the skilled person will appreciate, various changes and modifications can be made to the described embodiment. It is intended to include all such variations, modifications and equivalents which fall within the scope of the present invention, as defined in the accompanying claims.

What is claimed is:

1. A wine tasting carrier, comprising:
an original carrier, providing no special flavor and being in a shape of human's tongue;
a flavourless region, arranged on the original carrier;
a flavor carrying region, arranged on the original carrier and providing a flavor different from the flavor of the original carrier;
a producing material, attached on the flavor carrying region to provide the flavor of the flavor carrying region; and
a boundary line, arranged on the original carrier to divide a surface of the original carrier into the flavor carrying region and the flavourless region;
wherein, the flavor carrying region is arranged at a tip position, a middle position, a rear position, a circular area from a front to two sides, or two separated sides of the wine tasting carrier without overlapping the flavourless region, and the flavor of the flavor carrying region is corresponding to one of a plurality of flavors or aromas of a selected wine according to an arranged position of the flavor carrying region on the wine tasting carrier.

2. The wine tasting carrier of claim 1, wherein the boundary line is formed on the original carrier through a solid line or dotted lines to separate the flavor carrying region and the flavourless region.

3. The wine tasting carrier of claim 1, wherein the flavor carrying region is arranged at the tip position of the wine tasting carrier on one side of the boundary line, the flavourless region is arranged at a position of the wine tasting carrier on the other side of the boundary line, and the flavor of the flavor carrying region is a sweetness flavor of the selected wine.

4. The wine tasting carrier of claim 1, wherein two boundary lines are formed on the original carrier, the flavor carrying region is arranged at the middle position of the wine tasting carrier encompassed by the two boundary lines, two flavourless regions are respectively arranged at positions of the wine tasting carrier on the other side of the two boundary lines, and the flavor of the flavor carrying region is a primary aroma or a secondary aroma of the selected wine.

5. The wine tasting carrier of claim 1, wherein the flavor carrying region is arranged at the rear position of the wine tasting carrier on one side of the boundary line, the flavourless region is arranged at a position of the wine tasting carrier on the other side of the boundary line, and the flavor of the flavor carrying region is a secondary aroma or a tertiary aroma of the selected wine.

6. The wine tasting carrier of claim 1, wherein the flavor carrying region is arranged at the circular area from the front to the two sides of the wine tasting carrier on one side of the boundary line, the flavourless region is arranged at a position of the wine tasting carrier on the other side of the boundary line, and the flavor of the flavor carrying region is a tannin flavor of the selected wine.

7. The wine tasting carrier of claim 1, wherein two boundary lines are formed on the original carrier, two flavor carrying regions are respectively arranged at the two separated sides of the wine tasting carrier on one side of each of the two boundary lines, the flavourless region is arranged at a position of the wine tasting carrier encompassed by the two boundary lines, and the flavor of the two flavor carrying regions is an acidity flavor of the selected wine.

8. The wine tasting carrier of claim 1, wherein the flavor carrying region is constructed in a three-dimensional wave shape or a three-dimensional wrinkle shape and the flavourless region is planar.

9. A carrier set for wine tasting, corresponding to multiple flavors or aromas that are present in a selected wine, comprising:
a plurality of wine tasting carriers, each of the plurality of wine tasting carriers respectively comprises:
an original carrier, providing no special flavor and being in a shape of human's tongue;
a flavourless region, arranged on the original carrier;
a flavor carrying region, arranged on the original carrier, providing a flavor corresponding to the selected wine and different from the flavor of the original carrier;
a producing material, attached on the flavor carrying region to provide the flavor of the flavor carrying region; and
a boundary line, arranged on the original carrier to divide a surface of the original carrier into the flavor carrying region and the flavourless region;
wherein, each of the plurality of wine tasting carriers respectively has the flavor carrying region at different position of the wine tasting carrier, and the flavor of the flavor carrying region of each of the plurality of wine tasting carriers is respectively corresponding to different flavors or aromas of the selected wine according to an arranged position of the flavor carrying region on each of the wine tasting carriers.

10. The carrier set for wine tasting of claim 9, wherein the boundary line is formed on the original carrier through a solid line or dotted lines to separate the flavor carrying region and the flavourless region.

11. The carrier set for wine tasting of claim 9, wherein at least one of the plurality of wine tasting carriers has the flavor carrying region arranged at a tip position of the wine tasting carrier on one side of the boundary line, and has the flavourless region arranged at a position of the wine tasting carrier on the other side of the boundary line, wherein the flavor of the flavor carrying region is a sweetness flavor of the selected wine.

12. The carrier set for wine tasting of claim 9, wherein at least one of the plurality of wine tasting carriers has two boundary lines formed on the original carrier, has the flavor carrying region arranged at a middle position of the wine tasting carrier encompassed by the two boundary lines, and has two flavourless regions respectively arranged at positions of the wine tasting carrier on the other side of each of the two boundary lines, wherein the flavor of the flavor carrying region is a primary aroma or a secondary aroma of the selected wine.

13. The carrier set for wine tasting of claim 9, wherein at least one of the plurality of wine tasting carriers has the flavor carrying region arranged at a rear position of the wine tasting carrier on one side of the boundary line, and has the flavourless region arranged at a position of the wine tasting carrier on the other side of the boundary line, wherein the flavor of the flavor carrying region is a secondary aroma or a tertiary aroma of the selected wine.

14. The carrier set for wine tasting of claim 9, wherein at least one of the plurality of wine tasting carriers has the flavor carrying region arranged at a circular area from a front to two sides of the wine tasting carrier on one side of the boundary line, and has the flavourless region arranged at a position of the wine tasting carrier on the other side of the boundary line, wherein the flavor of the flavor carrying region is a tannin flavor of the selected wine.

15. The carrier set for wine tasting of claim 9, wherein at least one of the plurality of wine tasting carriers has two boundary lines formed on the original carrier, two flavor carrying regions respectively arranged at two separated sides of the wine tasting carrier on one side of each of the two boundary lines, and has the flavourless region arranged at a position of the wine tasting carrier encompassed by the two boundary lines, wherein the flavor of the two flavor carrying regions is an acidity flavor of the selected wine.

16. The carrier set for wine tasting of claim 9, wherein the flavor carrying region is constructed in a three-dimensional wave shape or a three-dimensional wrinkle shape and the flavourless region is planar.

17. The carrier set for wine tasting of claim 9, wherein the plurality of wine tasting carriers at least comprises a first wine tasting carrier, a second wine tasting carrier, a third wine tasting carrier, a fourth wine tasting carrier, and a fifth wine tasting carrier, wherein the first wine tasting carrier comprises a first flavor carrying region arranged at a tip position of the first wine tasting carrier and the first flavor carrying region is configured to provide a sweetness flavor of the selected wine, the second wine tasting carrier comprises a second flavor carrying region arranged at a middle position of the second wine tasting carrier and the second flavor carrying region is configured to provide a primary aroma or a secondary aroma of the selected wine, the third wine tasting carrier comprises a third flavor carrying region arranged at a rear position of the third wine tasting carrier and the third flavor carrying region is configured to provide the secondary aroma or a tertiary aroma of the selected wine, the fourth wine tasting carrier comprises a fourth flavor carrying region arranged at a circular area from a front to two sides of the fourth wine tasting carrier and the fourth flavor carrying region is configured to provide a tannin flavor of the selected wine, and the fifth wine tasting carrier comprises a fifth flavor carrying region arranged at two separated sides of the fifth wine tasting carrier and the fifth flavor carrying region is configured to provide an acidity flavor of the selected wine.
